(19) United States
(12) Patent Application Publication
(10) Pub. No.: US 2024/0087799 A1
(43) Pub. Date: Mar. 14, 2024

(54) INDUCTOR DEVICE

(71) Applicant: LITE-ON TECHNOLOGY CORPORATION, Taipei (TW)

(72) Inventors: Kai-De CHEN, Taipei (TW); Yong-Long SYU, Taipei (TW); Chen CHEN, Taipei (TW); De-Jia LU, Taipei (TW); Chao-Lin CHUNG, Taipei (TW)

(21) Appl. No.: 17/991,590

(22) Filed: Nov. 21, 2022

(30) Foreign Application Priority Data
Sep. 8, 2022 (CN) 202211097190.4

(51) Int. Cl. H01F 27/30; H01F 27/26

(52) U.S. Cl. CPC H01F 27/306; H01F 27/266

(57) ABSTRACT

An inductor device including a frame portion, a first winding set, a second winding set and a first common magnetic core I piece is provided. The first winding set, the second winding set and the first common magnetic core I piece are disposed in the frame portion. The first common magnetic core I piece substantially connects the first winding set and the second winding set and the frame portion. The material of the two winding sets is different from that of the first common magnetic core I piece.

This application claims the benefit of People's Republic of China application Serial No. 202211097190.4, filed Sep. 8, 2022, the subject matter of which is incorporated herein by reference.

### BACKGROUND OF THE INVENTION

### Field of the Invention

The invention relates in general to an inductor device.

### Description of the Related Art

Generally speaking, the magnetic core of a conventional integrated inductor can be formed of a high magnetic permeability material, such as ferrite. High magnetic permeability material requires a larger air gap, which generates a larger leakage of magnetic flux and greatly increases copper loss. Additionally, the conventional integrated inductor is unsuitable to be used during three-phase input or one-phase input, and the circuit control is complicated. For instance, when the winding direction of the three-phase inductor is clockwise, the common magnetic core I piece will generate magnetic flux cancellation during one-phase input, but the magnetic flux of the common magnetic core I piece will become large (such as 360 mT) during three-phase input. However, when the winding directions of the three-phase inductor are different (such as clockwise, anti-clockwise and clockwise in sequence), the common magnetic core I piece will have a larger magnetic flux (such as 450 mT) during one-phase input, but the common magnetic core I piece will generate magnetic flux cancellation during three-phase input. Hence, the conventional integrated inductor is unsuitable to be used during three-phase input or one-phase input. Furthermore, when the magnetic flux of the common magnetic core I piece is over the saturated magnetic flux (such as 400˜420 mT) of ferrite, the ferrite magnetic core will be saturated and cannot function properly. Therefore, it has become a prominent task for the industries to provide a solution to resolve the able problems.

### SUMMARY OF THE INVENTION

The invention is directed to an inductor device for resolving the problems encountered in the prior art.

According to one embodiment of the present invention, an inductor device including a frame portion, a first winding set, a second winding set and a first metal piece is provided. The first winding set, the second winding set and the first metal piece are disposed in the frame portion. The first metal piece substantially connects the first winding set, the second winding set and the frame portion. The material of the two winding sets is different from that of the first metal piece.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a multi-phase integrated inductor according to an embodiment of the invention.

FIG. 2 is a front view of a multi-phase integrated inductor according to an embodiment of the invention.

FIG. 3 is a front view of a multi-phase integrated inductor according to a comparison example.

FIG. 4 is a waveform diagram of alternating current of a multi-phase integrated uncoupled inductor.

FIG. 5 is a schematic diagram of a multi-phase integrated inductor according to another comparison example.

FIG. 6 is a waveform diagram of alternating current of a multi-phase integrated coupled inductor.

### DETAILED DESCRIPTION OF THE INVENTION

Technical solutions for the embodiments of the present application are clearly and thoroughly disclosed with accompanying drawings. Obviously, the embodiments disclosed below are only some rather than all of the embodiments of the present application. All embodiments obtained by anyone ordinarily skilled in the technology field of the present application according to the disclosed embodiments of the present application are within the scope of protection of the present invention if the obtained embodiments lack innovative labor. Similar/identical designations are used to indicate similar/identical elements.

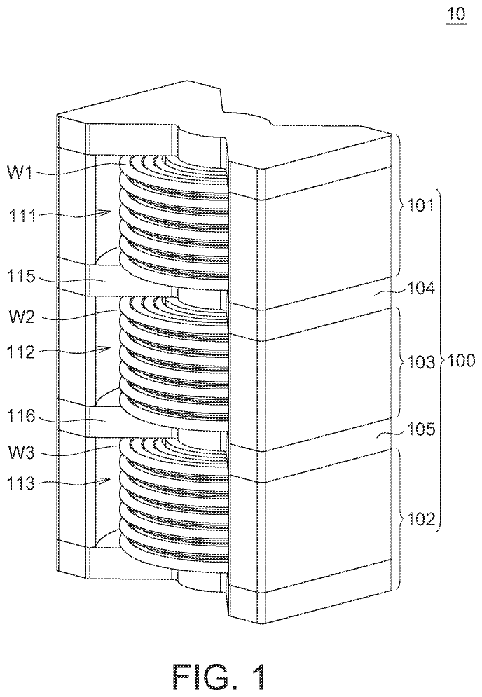

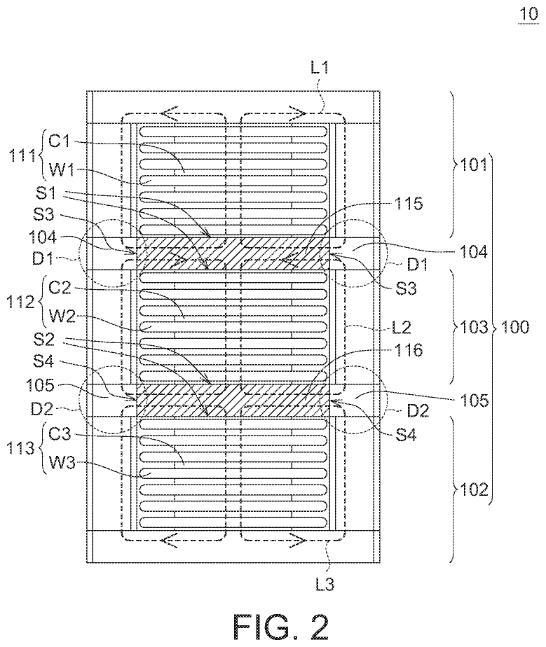

Referring to FIG. 1 and FIG. 2, a schematic diagram and a front view of a multi-phase integrated inductor 10 according to an embodiment of the invention are respectively shown. FIG. 1 and FIG. 2 are exemplified by the multi-phase integrated inductor 10 having 3 winding wires, but the present invention is not limited thereto. The number of winding wires W1-W3 can be greater than 3 or equivalent to 2.

The multi-phase integrated inductor 10 includes a frame portion 100, a first winding set 111, a second winding set 112, a third winding set 113, a first metal piece (referred as the first common magnetic core I piece hereinafter) 115 and a second metal piece (referred as the second common magnetic core I piece hereinafter) 116, wherein the first winding set 111, the second winding set 112, the third winding set 113, the first common magnetic core I piece 115 and the second common magnetic core I piece 116 all are disposed in the frame portion 100; the first common magnetic core I piece 115 and the second common magnetic core I piece 116 substantially connect the first winding set 111, the second winding set 112, the third winding set 113 and the frame portion 100. The material of the first, second, and third winding sets 111-113 is different from that of the first and second common magnetic core I pieces 115-116.

To put it in greater details, the first winding set 111 includes a magnetic core C1 and a first winding wire W1 surrounding the magnetic core C1; the second winding set 112 includes a magnetic core C2 and a second winding wire W2 surrounding the magnetic core C2; the third winding set 113 includes a magnetic core C3 and a third winding wire W3 surrounding the magnetic core C3. The magnetic cores C1-C3 are co-axially disposed. The first and second common magnetic core I pieces 115-116 are respectively interposed between adjacent two of the magnetic cores C1-C3 and are staggered with the magnetic cores C1-C3.

The frame portion 100 is formed of a low magnetic permeability material, and the magnetic cores C1-C3 of the first, second, and third winding sets 111-113 can also be formed of a low magnetic permeability material. Low magnetic permeability material, provided with the properties of high saturated flux and resistance to high DC magnetic flux, can avoid the magnetic fluxes of the first, second, and third winding sets 111-113 being too large and generating a saturation phenomenon, which would otherwise cause the inductor to be overheated and perform at a low efficiency.

Besides, in comparison to high magnetic permeability material, low magnetic permeability material does not require a larger air gap, which would otherwise generate a larger leakage of magnetic flux and greatly increase copper loss of the winding wires W1-W3. In an embodiment, the magnetic cores C1-C3 of the first, second, and third winding sets 111-113 can be formed of a low magnetic permeability powder core, which can be realized by such as a ferrosilicon magnetic core or a FeSiAl magnetic core. The frame portion 100 and the magnetic cores C1-C3 of the first, second, and third winding sets 111-113 can be formed of a low magnetic permeability powder core with identical or different materials.

Additionally, the first and second common magnetic core I pieces 115-116 are formed of a high magnetic permeability material, such as a ferrite. Due to the lower magnetoresistance of high magnetic permeability material, the magnetoresistance generated between adjacent two of the winding wires W1-W3 is lower to avoid inductor coupling. For instance, the first and second common magnetic core I pieces 115-116 have a magnetic permeability greater than or equivalent to 2000; the frame portion 100 and the magnetic cores C1-C3 of the first, second, and third winding sets 111-113 have a magnetic permeability less than 100 or 50.

As indicated in FIG. 1 and FIG. 2, the first common magnetic core I piece 115 is interposed between the first and second winding sets 111-112, and the first common magnetic core I piece 115 is completely or tightly engaged with the contact surfaces S1 of the first and second winding sets 111-112 without creating any effective air gap. Thus, during three-phase input, the magnetic path of the first common magnetic core I piece 115 will generate magnetic flux cancellation to avoid the magnetic flux being too large and generating a saturation phenomenon. Also, the second common magnetic core I piece 116 is interposed between the second and third winding sets 112 and 113, and the second common magnetic core I piece 116 is completely or tightly engaged with the contact surfaces S2 of the second and third winding sets 112 and 113 without creating any effective air gap. Thus, during three-phase input, the magnetic path of the second common magnetic core I piece 116 will generate magnetic flux cancellation to avoid the magnetic flux being too large and generating a saturation phenomenon.

In an embodiment, the winding numbers of adjacent two of the winding wires W1-W3 of the first, second and third winding sets 111-113 can be identical or different. Furthermore, the winding directions of adjacent two of the winding wires W1-W3 of the first, second and third winding sets 111-113 can be identical or different. For instance, the winding numbers and directions of the first winding wire W1 are different from that of the second winding wire W2; the winding numbers and directions of the second winding wire W2 are different from that of the third winding wire W3.

As indicated in FIG. 1 and FIG. 2, the winding number of the first winding wire W1 can be greater than that of the second winding wire W2 (such as 24 rings); the winding numbers of the third winding wire W3 can be greater than that of the second winding wire W2 (such as 24 rings). The number of first winding wire W1 is identical with the winding number of the third winding wire W3 (such as 29 rings). Thus, the winding numbers of the topmost and bottommost winding sets are greater than the winding number of the winding set interposed between the topmost and bottommost winding sets.

Besides, the winding direction of the first winding wire W1 can be anti-clockwise; the winding direction of the second winding wire W2 can be clockwise; the winding direction of the third winding wire W3 can be anti-clockwise. When the winding directions of adjacent two of the winding wires W1-W3 are different, the magnetic field between adjacent two of the winding wires W1-W3 will generate magnetic flux cancellation during three-phase input, making the magnetic fluxes of the first winding wire W1 and the third winding wire W3 (such as 181 pH or less) greater than the magnetic flux of the second winding wire W2 (such as 174 pH or larger). Therefore, the magnetic fluxes of the topmost and bottommost winding sets are greater than the magnetic flux of the winding set interposed between the topmost and bottommost winding sets. In an embodiment, take the inductor used in a 11 kW vehicle power for instance. The difference between the magnetic fluxes of the first winding wire W1 and the third winding wire W3 and the magnetic flux of the second winding wire W2 preferably is controlled to be less than ±5%.

As indicated in FIG. 1 and FIG. 2, the first common magnetic core I piece 115 substantially contacts and is tightly engaged with two opposite sides of the frame portion 100; the second common magnetic core I piece 116 substantially contacts and is tightly engaged with two opposite sides of the frame portion 100. The frame portion 100 and the magnetic cores C1-C3 can be integrally formed in one piece from low magnetic permeability powder cores formed of identical materials or can be composed of several E pieces formed by several frame portions and several magnetic cores and stacked together. For instance, the frame portion 100 includes an upper frame portion 101 (the first frame portion), a lower frame portion (the second frame portion) 102, a middle frame portion (the third frame portion) 103, a first connection portion 104 and a second connection portion 105, wherein the first connection portion 104, interposed between the upper frame portion 101 and the middle frame portion 103, substantially contacts and is tightly engaged with two opposite sides S3 of the first common magnetic core I piece 115. Also, the second connection portion 105, interposed between the middle frame portion 103 and the lower frame portion 102, substantially contacts and is tightly engaged with two opposite sides S4 of the second common magnetic core I piece 116.

As indicated in FIG. 2, when a current is introduced to the first winding wire W1, the upper frame portion 101, the first connection portion 104 and the first common magnetic core I piece 115 can form a closed first magnetic path L1 on the periphery of the first winding set 111; when a current is introduced to the second winding wire W2, the middle frame portion 103, the first connection portion 104, the second connection portion 105, the first common magnetic core I piece 115 and the second common magnetic core I piece 116 can form a closed second magnetic path L2 on the periphery of the second winding set 112; when a current is introduced to the third winding wire W3, the lower frame portion 102, the second connection portion 105 and the second common magnetic core I piece 116 can form a closed third magnetic path L3 on the periphery of the third winding set 113. Thus, the phases of the first, second and third winding wires W1-W3 can be independently operated to form a multi-phase integrated uncoupled inductor.

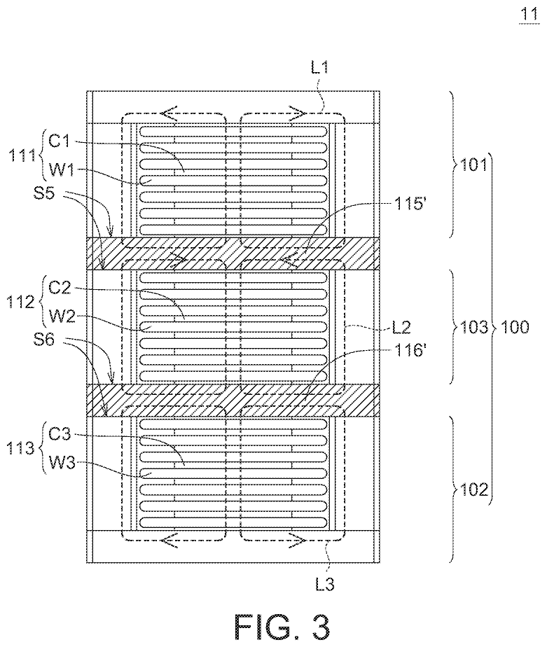

Referring to FIG. 3, a front view of a multi-phase integrated inductor 10 according to the second embodiment is shown. The three-phase integrated inductor 11 of FIG. 2 is different from the three-phase integrated inductor 10 of FIG. 3 in that the frame portion 100 of FIG. 3 includes an upper frame portion 101, a lower frame portion 102 and a middle frame portion 103, wherein the upper frame portion 101 and the middle frame portion 103, respectively stacked on the top and bottom of the first common magnetic core I piece 115′, substantially contact and are tightly engaged with two opposite sides S5 of the first common magnetic core I piece 115′; the middle frame portion 103 and the lower frame portion 102, respectively stacked on the top and bottom of the second common magnetic core I piece 116′, substantially contact and are tightly engaged with two opposite sides S6 of the second common magnetic core I piece 116′. Due to the increase in the length of the first common magnetic core I piece 115′ and the second common magnetic core I piece 116′, the first connection portion 104 and the second connection portion 105 of FIG. 2 are not needed.

In FIG. 3, the upper frame portion 101 and the first common magnetic core I piece 115′ can form a closed first magnetic path L1 on the periphery of the first winding set 111; the middle frame portion 103, the first common magnetic core I piece 115′ and the second common magnetic core I piece 116′ can form a closed second magnetic path L2 on the periphery of the second winding set 112; the lower frame portion 102 and the second common magnetic core I piece 116′ can form a closed third magnetic path L3 on the periphery of the third winding set 113. Thus, the phases of the first, second and third winding wires W1-W3 can be independently operated to form a multi-phase integrated uncoupled inductor.

FIG. 2 and FIG. 3 both can effectively reduce the impact of inductor coupling but are different in that the first and second common magnetic core I pieces 115-116 of FIG. 2 are shorter than the first and second common magnetic core I pieces 115′-116′ of FIG. 3. Therefore, the design of the magnetic path of FIG. 2 can avoid the magnetic flux of the magnetic cores between the first and second common magnetic core I pieces 115-116 and the magnetic fluxes at the connection regions of the two sides of the I pieces 115-116 being too large and generating a saturation phenomenon. Conversely, the design of the magnetic path of FIG. 3 may cause the inductor to be overheated or have a low efficiency due to the magnetic flux at the magnetic core between the first and second common magnetic core I pieces 115′-116′ and the magnetic fluxes at the connection regions of the two sides of the I pieces 115′-116′ being too large.

Thus, in the present embodiment, the design of the magnetic loop of FIG. 3 is changed to the design of the magnetic loop of FIG. 2, the frame portion 100 is formed of a low magnetic permeability material, and the first and second common magnetic core I pieces 115-116 are formed of a high magnetic permeability material and have a shorter length to avoid generating a saturation phenomenon, which would otherwise cause the inductor to be overheated and perform at a low efficiency.

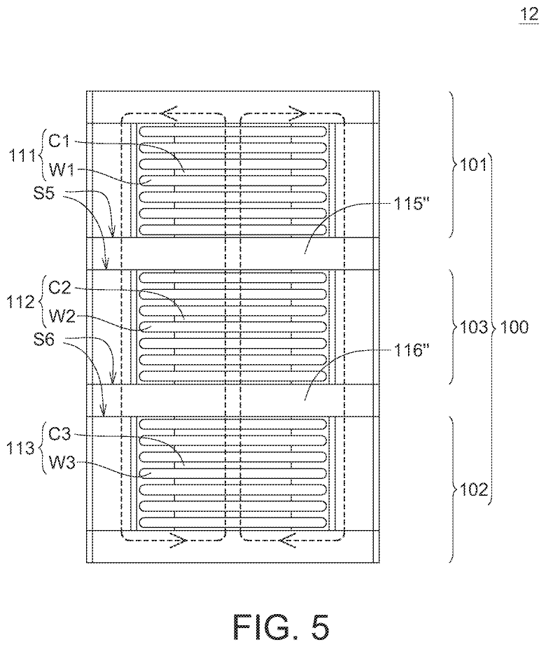

Referring to FIG. 5, an appearance diagram of a multi-phase integrated inductor 12 according to another comparison example is shown. The three-phase integrated inductor 12 of FIG. 5 is different from the three-phase integrated inductors 10-11 of FIGS. 2 and 3 in that the first and second common magnetic core I pieces 115″ and 116″ of FIG. 5 are formed of a low magnetic permeability material. That is, the first, second and third winding sets 111-113 as well as the first and second common magnetic core I pieces 115″ and 116″ of FIG. 5 all are formed of a low magnetic permeability material. Thus, each part of the magnetic cores of the said three-phase integrated inductor has identical magnetoresistance (or magnetic permeability) and all of the magnetic loops are interconnected, so that adjacent two of the winding wires W1-W3 can be coupled to form a three-phase integrated coupled inductor.

However, the three-phase integrated coupled inductor makes the difference of the magnetic flux between two adjacent winding sets greater than 8%, and increases the difficulty in the circuit control of PLC. Therefore, to avoid the formation of an integrated coupled inductor, in the present embodiment, the materials of the first and second common magnetic core I pieces 115 and 116 are changed to a high magnetic permeability material, and the winding numbers of adjacent two of the first, second and third winding sets 111-113 are designed to be different, and the winding directions of adjacent two of the first, second and third winding sets 111-113 are also designed to be different, so that the phases of the first, second, and third winding wires W1-W3 can be independently operated to form the multi-phase integrated uncoupled inductor of FIGS. 2 and 3. Thus, adjacent two of winding sets 111-113 will not have identical magnetoresistance (or magnetic permeability), and each magnetic field can return to respective magnetic paths L1-L3 via the low magnetoresistance path of respective common magnetic core I piece, so that the magnetic paths L1-L3 will not be coupled with each other.

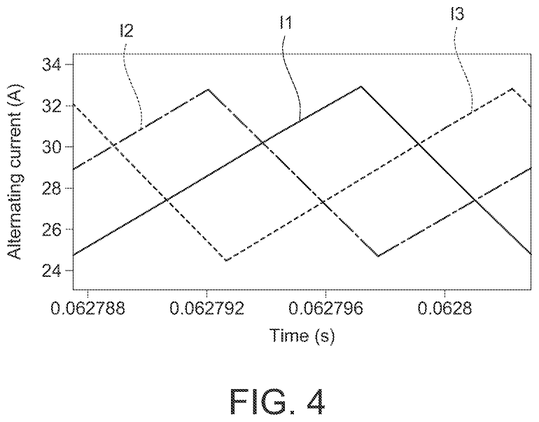

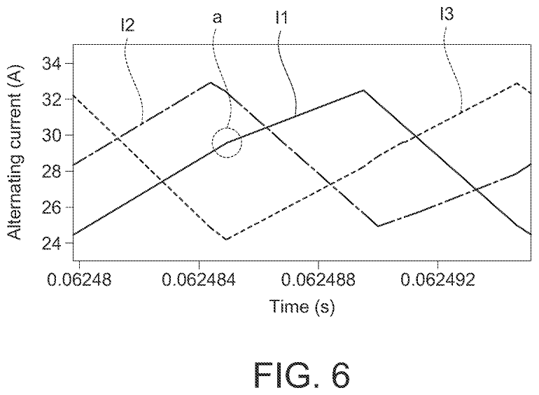

Referring to FIG. 4 and FIG. 6, a waveform diagram and a waveform diagram of alternating current of a multi-phase integrated coupled inductor are respectively shown. In FIG. 4, when the three-phase alternating currents I1, I2 and I3 are inputted to the multi-phase integrated uncoupled inductor in the form of triangular waves, the slopes of the three-phase alternating currents I1, I2 and I3 flowing through the first, second and third winding wires W1-W3 in the waveform diagram remain consistent. In FIG. 6, when the three-phase alternating currents I1, I2 and I3 are inputted to the multi-phase integrated coupled inductor in the form of triangular waves, the slopes of the three-phase alternating currents I1, I2 and I3 flowing through the first, second and third winding wires W1-W3 in the waveform diagram are changed due to the coupling effect (indicated by arrow a). Thus, the three-phase alternating currents I1, I2 and I3 of FIG. 6 have unstable waveforms and are difficult to control. In comparison, the three-phase alternating currents I1, I2 and I3 of FIG. 4 have stable waveforms and are easy to control.

In the multi-phase integrated inductor disclosed in above embodiments of the present invention, the magnetic core is formed of a low magnetic permeability material, hence avoiding the problems, which would otherwise occur if the magnetic core were formed of a high magnetic permeability material, for instance, the air gap is large, the leakage of magnetic flux is huge, and copper loss is greatly increased. Besides, in the multi-phase integrated inductor disclosed in above embodiments of the present invention, the common magnetic core I pieces are formed of a high magnetic permeability material, so that the magnetoresistance generated between two adjacent winding sets is lower, and two adjacent winding sets are completely or tightly engaged without creating any effective air gap, so that the magnetic fluxes of the multi-phase integrated inductor will not be too large and become saturated.

While the invention has been described by way of example and in terms of the preferred embodiment (s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. An inductor device, comprising:
a frame portion;
a first winding set having a first winding wire and a first magnetic core;
a second winding set having a second winding wire and a second magnetic core; and
a first metal piece, wherein the first winding set, the second winding set and the first metal piece are disposed in the frame portion, the first metal piece substantially connects the first winding set, the second winding set and the frame portion, and a material of the two winding sets is different from a material of the first metal piece.

2. The inductor device according to claim 1, wherein winding numbers of the two winding sets are identical or different.

3. The inductor device according to claim 1, wherein winding directions of the two winding sets are identical or different.

4. The inductor device according to claim 1, wherein the first metal piece is formed of a high magnetic permeability material; the two winding sets and the frame portion are formed of a low magnetic permeability material.

5. The inductor device according to claim 1, wherein the two magnetic cores are tightly engaged with two contact surfaces of the first metal piece.

6. The inductor device according to claim 1, further comprising a third winding set and a second metal piece, wherein the third winding set and the second metal piece are disposed in the frame portion, the first metal piece and the second metal piece respectively connect adjacent two of the first, second and third winding sets and the frame portion.

7. The inductor device according to claim 1, wherein the third winding set has a third winding wire and a third magnetic core.

8. The inductor device according to claim 7, wherein winding numbers of adjacent two of the three winding sets are identical or different.

9. The inductor device according to claim 7, wherein winding directions of adjacent two of the three winding sets are identical or different.

10. The inductor device according to claim 6, wherein the first and the second metal piece are formed of a high magnetic permeability material;
the three winding sets and the frame portion are formed of a low magnetic permeability material.

11. The inductor device according to claim 6, wherein adjacent two of the three winding sets respectively are tightly engaged with two contact surfaces of the first and the second metal pieces.

12. The inductor device according to claim 6, wherein the frame portion comprises a first frame portion, a second frame portion, a third frame portion, a first connection portion and a second connection portion, the first connection portion, interposed between the first and third frame portions, substantially contacts and is tightly engaged with two opposite sides of the first metal piece, wherein the second connection portion, interposed between the third and second frame portions, substantially contacts and is tightly engaged with two opposite sides of the second metal piece.

13. The inductor device according to claim 6, wherein the frame portion comprises a first frame portion, a second frame portion, and a third frame portion, wherein the first and third frame portions, respectively stacked on top and bottom of the first metal piece, are tightly engaged with two opposite sides of the first metal piece, wherein the third and second frame portions, respectively stacked on top and bottom of the second metal piece, are tightly engaged with two opposite sides of the second metal piece.
